(19) United States
(12) Patent Application Publication
(10) Pub. No.: US 2004/0010653 A1
(43) Pub. Date: Jan. 15, 2004

(54) Residential broadband communications device, and method of operating same

(75) Inventors: Kevin P. Grundy, Fremont, CA (US); Jeff Sidlosky, San Jose, CA (US); Creighton W. Chong, Fremont, CA (US); Douglas Cheline, San Jose, CA (US)

Correspondence Address: HUGHES ELECTRONICS CORPORATION, PATENT DOCKET ADMINISTRATION RE/R11/A109, P O BOX 956, EL SEGUNDO, CA, 90245-0956, US

(73) Assignee: Hughes Electronics Corporation

(21) Appl. No.: 10/374,776

(22) Filed: Mar. 10, 2003

Related U.S. Application Data
(63) Continuation of application No. 09/607,707, filed on Jun. 30, 2000, now abandoned.

(51) Int. Cl. G06F 15/16

(52) U.S. Cl. 710/315; 709/250

(57) ABSTRACT

An apparatus for communicating with a communication network includes a processor, communication circuitry that interfaces with a communication network, and a bus connecting the processor to the communication circuitry. A port is connected to the bus, which communicates using an external communication protocol specified by a peripheral device. A memory, comprising a translator module that converts signals between the external communication protocol and an internal communication protocol operates such that communication signals transmitted to the port are converted from the internal communication protocol to the external communication protocol and signals received by the port are converted from the external communication protocol to the internal communication protocol.

### BRIEF DESCRIPTION OF THE INVENTION

The present invention relates generally to telecommunications. More particularly, the present invention is directed toward a residential broadband telecommunications device.

### BACKGROUND OF THE INVENTION

Recently with the tremendous growth of the Internet and new-media services, such as streaming video, a huge demand for high speed communications services (packet based, data, and voice) has been created. These high speed communications services include broadband services which provide multiple channels of data over a single communications medium, typically using a form of frequency or wave division multiplexing. Broadband communication services include ADSL (Asynchronous Direct Subscriber Line), SDSL (Synchronous Direct Subscriber Line), Cable modem, ISDN (Integrated Services Digital Network), broadband wireless, and broadband satellite. This growing demand creates a significant deployment challenge to telecommunication carriers and high speed communications service providers. In addition, the operations of these new high speed communication services require new approaches in many areas, such as network infrastructure, order entry, provisioning, and account setup and configuration.

Existing modems for use with high speed communication services do not typically incorporate any features other than converting a single type of incoming signal into a signal understandable by a client computer. Such modems usually work in conjunction with a network card, such as an Ethernet card. A signal to be routed over a network to a modem is converted into an Ethernet signal, which is communicated over the network to a network card positioned in the client computer. The modem subsequently processes the signal from the network card.

Existing high speed modems typically cannot connect multiple client computers to the electronic network via the single modem without first splitting the converted signal using a router. Also, existing modems do not allow a computing device to be connected to the modem via a number of different types of interfaces, such as USB (Universal Serial Bus), parallel port, Ethernet, etc. This makes it difficult to connect to the Internet using older computing devices, which rarely have an Ethernet interface.

Currently, the provisioning of a new high speed communication service entails sending out multiple qualified technicians to the location of a client computer. Often, for broadband services such as DSL, both a telephone company technician and a service provider technician must call on the location of the client computer to setup the service. In addition to installing the hardware (modem and network card), the technician loads the necessary software and then has to manually enter the network parameters, such as IP (Internet Protocol), DNS (Domain Name Server), and Gateway addresses.

In view of the foregoing, it would be highly desirable to provide an improved technique to facilitate residential broadband communication services. Ideally, the technique would be compatible with all types of residential computers and the service could be easily invoked by a technically unsophisticated individual.

### SUMMARY OF THE INVENTION

An apparatus for communicating with a communication network includes a processor, communication circuitry that interfaces with a communication network, and a bus connecting the processor to the communication circuitry. A port is connected to the bus, which communicates using an external communication protocol specified by a peripheral device.

A memory, comprising a translator module that converts signals between the external communication protocol and an internal communication protocol operates such that communication signals transmitted to the port are converted from the internal communication protocol to the external communication protocol and signals received by the port are converted from the external communication protocol to the internal communication protocol.

### BRIEF DESCRIPTION OF THE DRAWINGS

For a better understanding of the invention, reference should be made to the following detailed description taken in conjunction with the accompanying drawings, in which:

FIG. 1 illustrates a residential broadband communication device constructed in accordance with an embodiment of the invention.

FIG. 2 illustrates routing operations performed by the device of FIG. 1.

FIG. 3 illustrates an Ethernet packet format used in accordance with the invention to process signals from a parallel port.

FIG. 4 illustrates the routing of data from a parallel port in accordance with an Ethernet protocol utilized in accordance with an embodiment of the invention.

FIG. 5 illustrates the residential broadband communications device of the invention forming a portion of a larger network.

FIG. 6 illustrates a central office forming a portion of the network of FIG. 5.

FIG. 7 illustrates a configuration system forming a portion of the network of FIG. 5.

FIGS. 8A-8B illustrate processing steps performed to activate service for a residential broadband communications device of the invention.

Like reference numerals refer to corresponding parts throughout the drawings.

### DETAILED DESCRIPTION OF THE INVENTION

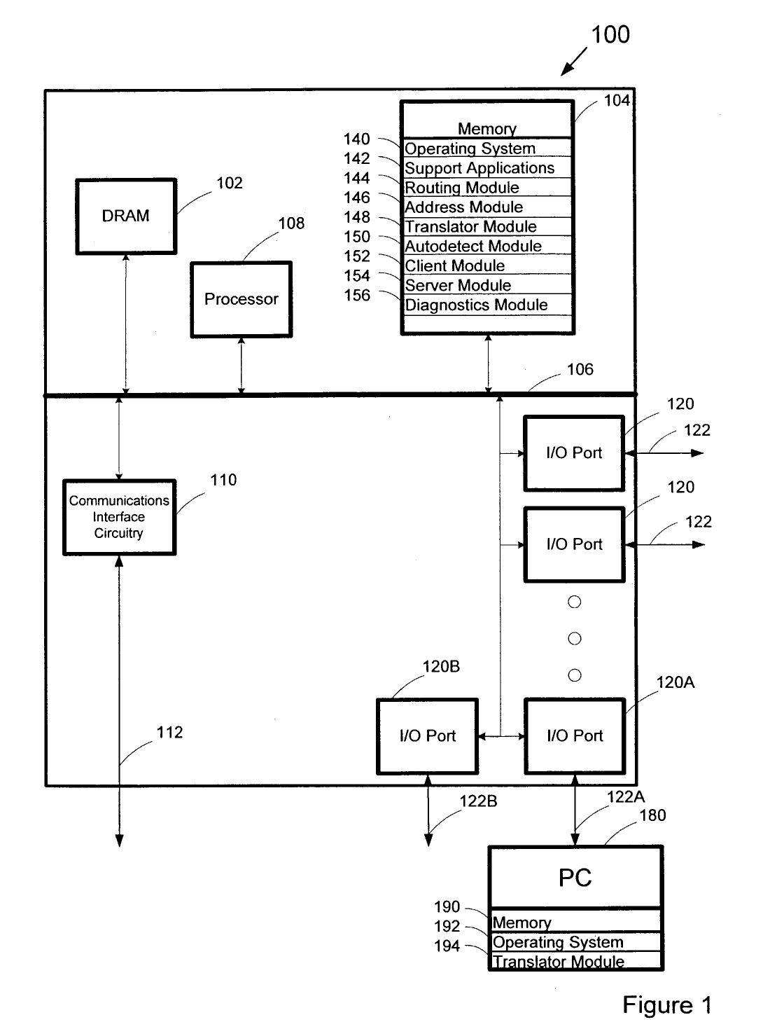

FIG. 1 illustrates a residential broadband communication device, or gateway, 100 according to an embodiment of the invention. In one embodiment of the invention, the gateway 100 includes a processor 108, volatile memory 102 (e.g., Dynamic Random Access Memory—DRAM), and a non-volatile memory 104 (e.g., Flash Programmable Memory) which stores a set of executable programs.

The memory 104 stores an operating system 140, which is downloaded to memory 102 via bus 106. The memory also stores support applications 142, which may be integrated with the operating system 140. The memory also stores a routing module 144, an address module 146, and a translator module 148, which are used to route data packets, as discussed below. The memory also stores an autodetect module 150, a client module 152, server module 154, and a diagnostics module 156, which are used to initiate and update service to the gateway 100, as discussed below.

The gateway 100 further comprises communications interface circuitry 110 to support broadband communications over a broadband link 112. In one embodiment of the invention, the communications interface circuitry 110 is configured to accept Asymmetric Digital Subscriber Line (ADSL) signals. In other embodiments, the communications interface circuitry 110 is configured to accept signals from other broadband links 112 including, but not limited to, a Synchronous Digital Subscriber Line (SDSL), an Integrated Services Digital Network (ISDN) Digital Subscriber Line (IDSL), a cable, or a Plain Old Telephone Service line (POTS). The communications interface circuitry 110 is a commercially available device; different devices are sold to support different broadband services.

In accordance with the invention, the gateway 100 supports a number of ports to interface with a variety of peripheral devices. In one instance, a personal computer 180 is connected to port 120A via an I/O link 122A. The I/O link 122A may be a serial port, a parallel port, a universal serial bus (USB) or any other communication port used to transfer communication signals from one computing device to another.

Observe at this point that the gateway 100 is a standalone device that supports broadband services. Observe further that the gateway 100 includes a number of I/O ports 120 for connection to a variety of peripheral devices. Also note that a personal computer 180 may be attached to the gateway 100 using a variety of links available on the personal computer 180. Thus, the invention is advantageous because a legacy computer with a limited number of I/O ports (e.g., only a parallel port) can still be used in connection with broadband services.

In one embodiment of the invention, the operating system 140 is downloaded into volatile memory 102 from non-volatile memory 104 when the gateway 100 is booted (turned-on). The support applications 142 and other modules, which may include but are not limited to, a routing module 144, an address module 146, a translator module 148, an autodetect module 150, a client module 152, a server module 154, and a diagnostics module 156, are either integrated with the operating system 140 and downloaded when the gateway 100 is booted or they are selectively called by the operating system 140 after the operating system 140 is downloaded into memory 102. The support applications 142 enable the use of devices attached via the I/O links 122 to the I/O ports 120. Support applications 142 may support the use of telephony, digital packetization, encryption, home security and other applications.

In a preferred embodiment of the invention, one of the I/O Ports 120A is associated with a real Internet Protocol (IP) address. Preferably, all other I/O Ports 120 are associated with non-routable IP addresses, meaning that the addresses are routable within the gateway 100, but not outside of the gateway. This configuration has the advantage of conserving IP addresses, which are becoming increasingly difficult to acquire.

The present embodiment of the invention includes an autodetect module 150 that is configured to detect Local Exchange Carrier (LEC) Virtual Path Identifier/Virtual Channel Identifier (VPI/VCI) values. Utilizing the client module 152, the gateway 100 can access a server, provide VPI/VCI values, and receive a real IP address. The system for accomplishing this procedure is disclosed below.

In one embodiment of the invention, the user specifies which I/O Port 120A is associated with the real IP address. The address module 146, which may be implemented as a non-volatile memory in another embodiment of the invention, determines the local IP addresses for the gateway 100. Preferably, the local IP addresses that correspond to non-routable I/O Ports 120 are static, being defined at the time of manufacture. Since the non-routable ports are local to the gateway 100, each gateway manufactured can have the same addresses for the non-routable ports.

For simplicity and legacy compatibility, preferably there are multiple I/O ports 120 so that any external or perhipheral device can be connected through the corresponding I/O Link 122. Although in the present embodiment support applications 142 are stored in Memory 104, an I/O Port 120 can contain programmable circuitry or an attached computing device can contain the support applications associated with attached I/O devices. Advantageously, the I/O Ports 120, in conjunction with the support applications 142, make the gateway 100 an external plug-and-play device capable of operation without installation of other cards.

The gateway 100 and the PC 180 send packetized data along the I/O Link 122A. Similar to the gateway 100, the PC 180 has an operating system 192 and a translator module 194 stored in its memory 190. Typically, the translator module 194 is downloaded into the memory 190 using a computer readable medium that is shipped with the gateway 100.

The translator module 148 on the gateway 100 and the translator module 194 on the peripheral 180 encode and decode data packets transmitted through a parallel port I/O link 122A. Thus, the invention supports packetized communications to a personal computer even when the personal computer is limited to a parallel port I/O link. The invention is disclosed in the context of Ethernet packetized communications, as discussed below.

In one embodiment of the invention, the communication interface circuitry 110 receives and sends ADSL signals through the broadband link 112. In a preferred embodiment of the invention, the communications interface circuitry 110 enables the gateway 100 to function as an edge router that routes data between one or more Local Area Networks (LANs) and an Asynchronous Transfer Mode (ATM) backbone network, preferably a Wide Area Network (WAN). Advantageously, this embodiment of the invention can have multiple WAN front ends by modifying the communications interface circuitry 110 to allow the use of any broadband signal, including but not limited to SDSL, cable, wireless, satellite, and IDSL signals. Of course, the components of the WAN will vary depending on the type of broadband signal used. In another embodiment of the invention, the gateway 100 includes redundant configuration paths, preferably a modem, to enable continued communications when the broadband link 112 is down. The redundant modem is used with a Plain Old Telephone Service (POTS) link. The redundant modem and POTS link are used to receive configuration information and for diagnostic activity.

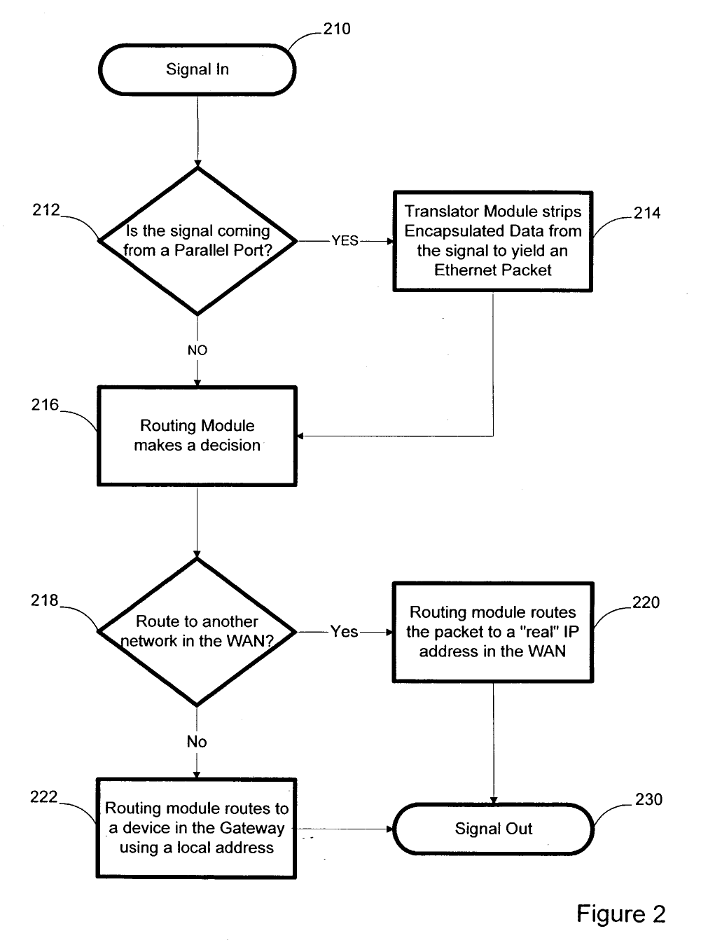

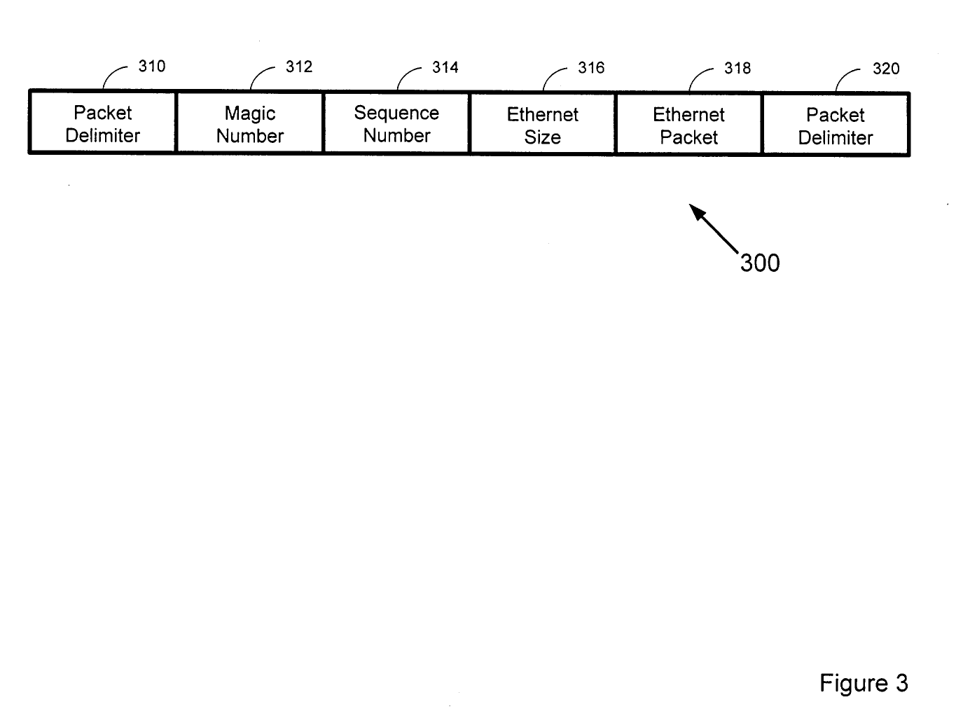

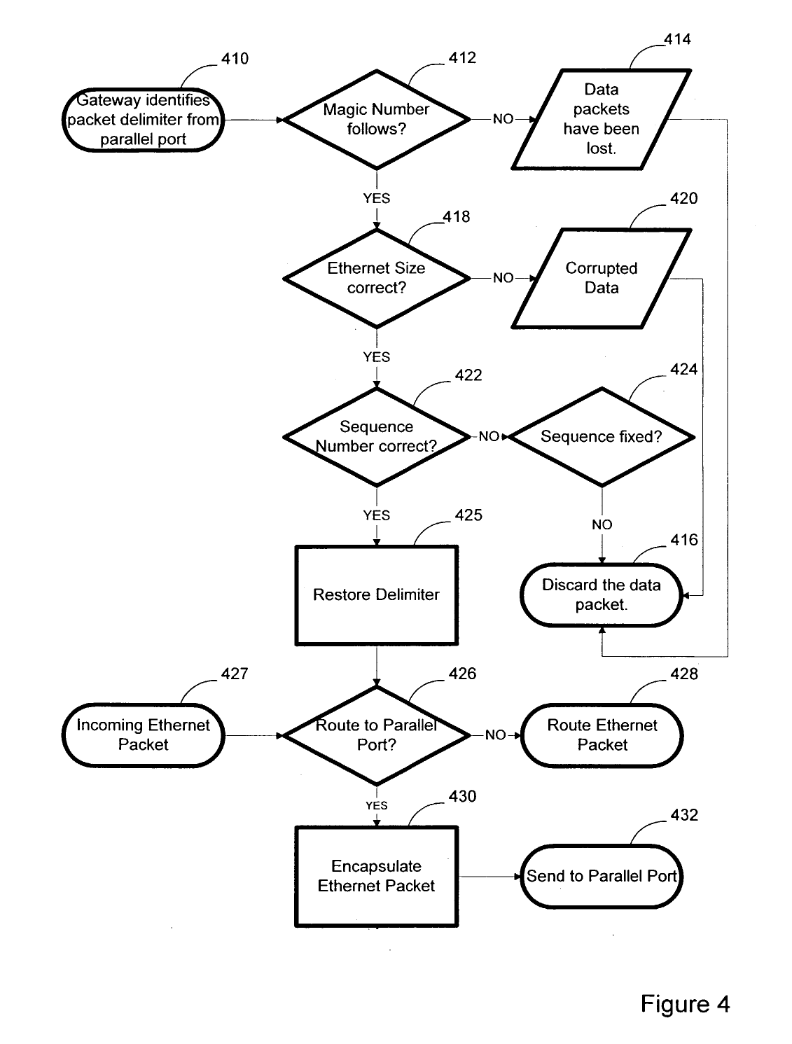

FIG. 2 illustrates the procedure for routing a signal received from one of the I/O Ports 120 through I/O Links 122. Initially, a signal is received (step 210). The gateway 100 determines whether the signal is from a parallel port (step 212). If so, the translator module 148 strips the encapsulated data from the signal to yield an Ethernet packet (step 214). This processing is further discussed in connection with FIGS. 3 and 4.

If the incoming signal is not coming from the parallel port, then it is already in an Ethernet packet form. The Ethernet packet, regardless of its source, is then passed to the router 144 (step 216). The router assesses whether the packet is to be routed to another address in the Wide Area Network (step 218). If so, the router routes the packet to a “real” IP address in the WAN (step 220). If not, the router routes the packet to a non-routable port within the gateway (step 222).

The routing module 144 allows the gateway 100 to intelligently route incoming data between devices and/or networks attached to the gateway 100 through any of I/O Ports 120 or the communication interface circuitry 110. Because all signals processed by the gateway 100 are in a predetermined format (e.g., Ethernet) the routing module 144 is able to efficiently route incoming signals. Thus, the gateway 100 operates as a universal Ethernet router. Observe that the routing module 144 can operate to simply pass data through the gateway 100. Thus, the gateway can operate in a daisy-chain manner.

The ability of the gateway 100 to operate as a router is facilitated by its ability to process data from a parallel port. Parallel port data is received as a stream, not in packets, thus the gateway 100 must be configured to recognize packets within the stream. In accordance with the invention, a packet encapsulation technique is used. The packet encapsulation technique operates so that a delimiter associated with an Ethernet packet is ignored when it is within the encapsulated packet created in accordance with the invention.

FIG. 3 illustrates an Ethernet encapsulation format that may be used in accordance with an embodiment of the invention. The encapsulation format 300 includes a packet delimiter 310, followed by a “magic number” 312, a sequence number 314, an Ethernet size value 316, the Ethernet packet 318 (containing the data and packet delimiters to be ignored), and a packet delimiter 320. Each packet delimiter represents the beginning and end of each encapsulated packet. The “magic number” is a predetermined static number used to identify the packet as a valid packet upon which processing can be commenced. The sequence number increments each packet in both directions independently so the gateway 100 and the PC 180 can tell if a packet has been lost. The Ethernet size value is the size of the Ethernet packet that is being transferred. The Ethernet packet is the packet that is to be subsequently routed. The utilization of these values is more fully described in connection with FIG. 4.

The translator module 194 operating on the PC 180 encapsulates an Ethernet packet using the encapsulation format of FIG. 3. The gateway 100 reads each byte from the stream of data at the parallel port to identify a packet delimiter value. Since packet delimiters are used to mark an encapsulated packet 300 of the type shown in FIG. 3, it is crucial that a packet delimiter appearing in the Ethernet packet 318 be ignored. This is done by applying a predetermined function to each packet delimiter that is within an Ethernet packet 318. For example, the translator module 194 applies a predetermined function to each packet delimiter associated with an Ethernet packet 318 to “hide” its value, so that it is not erroneously processed as a packet delimiter of the encapsulated packet 300. For example, the predefined value and a constant value may be processed by an exclusive-Or (XOR) function to create a new value that will not be treated as a packet delimiter. Therefore, when the gateway receives a packet delimiter 310 from a parallel port, it knows that the packet delimiter is associated with an encapsulated packet 300, such as shown in FIG. 3.

FIG. 4 illustrates the processing performed by the translator module 148 of the gateway 100 in connection with signals received from the parallel port. The first processing step is to identify a packet delimiter from the parallel port (step 410). The gateway 100 then determines whether the magic number 312 follows (step 412). The magic number is a static, predetermined number that is used to identify whether the packet is valid. If not, the data packet has been lost (step 414) and it is discarded (step 416). If the magic number is valid, it is determined whether the Ethernet size is correct (step 418). If the Ethernet size is not correct, then there is corrupted data (step 418) and it is discarded (step 416).

Next, it is determined whether the sequence number is correct (step 422). The sequence number increments each packet in both directions independently so the gateway and the PC can tell whether a packet has been lost. If the sequence number is incorrect, an attempt is made to fix the sequence (step 424). If this is not successful, then the data packet is discarded (step 416).

If the proper sequence is re-constructed, then the delimiter in the Ethernet packet 318 is restored (step 425). In order to recover this value, an escape code is placed in front of the masked delimiter by the translator module 194 of the PC 180. When the escape code is subsequently read at the gateway 100, the gateway knows that the following value is likely to be an actual packet delimiter associated with the Ethernet packet. The actual packet delimiter is processed by a predetermined function to recover the original value. For example, another XOR function with the previously used constant can be performed to recover the original value. Preferably, the escape code is also processed by a predetermined function (e.g., an XOR function with a constant) to insure that the escape code and its associated masked value are not randomly occurring values.

At this point, the gateway 100 possess the Ethernet packet 318 as it existed prior to encapsulation. A determination is made whether the Ethernet packet is to be routed back to the parallel port (step 426). The decision at step 426 is also made for other Ethernet packets within the gateway (step 427). If packet is not addressed to the parallel port, the packet is routed by the routing module 144, as specified (step 428). If the Ethernet packet is to return to the PC via the parallel port, it is encapsulated using the format of FIG. 3 (step 430). This encapsulation process uses the previously discussed technique to mask delimiters associated with the Ethernet packet 318, so that the PC only processes the actual packet delimiters 310 and 320. The translator module 194 operating on the PC 180 performs steps 410-425 of FIG. 4. Once the PC 180 recovers the Ethernet packet 318, it processes the packet. If the PC 180 needs to communicate with the gateway, it encapsulates an Ethernet packet and sends it to the gateway via the parallel port.

Attention now turns to some of the remaining modules stored in memory 104 of the gateway 100. The autodetect module 150 detects a line's LEC VPI/VCI values through the broadband link 112. This permits the gateway 100 to send a DHCP broadcast signal. The server module 152 enables the gateway system 100 to act as a web or other server by awaiting and acting upon input signals received through any of I/O ports 120 or the communication circuitry 110. The gateway 100 may also be configured to include a voice recognition module 154. A voice recognition module can be used to allow a user to configure the gateway 100 by using voice commands. The diagnostics module 156 enables the gateway system 100 device to test the quality of external data paths by, in the case of phone lines, performing TDR testing for bridge taps and load coils, or, in the case of DSL, performing tone detection.

Attention is now directed to the operation of the gateway 100 in a larger network environment. In particular, the following discussion identifies how the gateway 100 is originally activated and is subsequently updated to supply broadband services in a larger network environment.

The present invention includes methods for automatically configuring a gateway that can transmit and receive information over a network, such as the Internet. The configuration of the gateway is accomplished with minimal human interaction. Once the gateway is acquired, the consumer connects the gateway to a device and a network. Preferably, the device is a personal computer and the network is a telephone network. The gateway configures itself and notifies the user when it is ready for use. During the course of its life, the device updates its configuration with bug fixes, new features, etc., without action by the user.

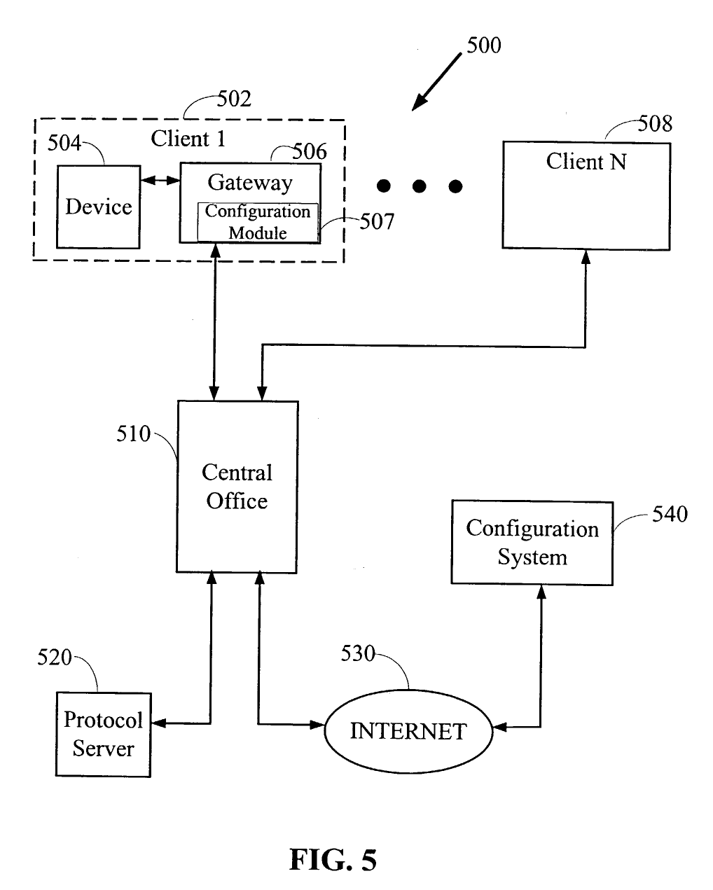

Referring to FIG. 5, system 500 is an exemplary embodiment of the environment the gateway configuration method operates within. Gateway 506 (equivalent to the gateway 100 of FIG. 1) is the item used for connecting a device 504 to a network. The gateway 506 is connected to a device (e.g., a personal computer) 504 without having to perform any physical modifications to the device 504. In the preferred embodiment, software that operates in conjunction with the gateway is installed on the device 504. Within the gateway 506 is a configuration module 507 that is responsible for the configuration of the gateway 506. One example of a user's device is a personal computer. Alternatively, device 504 can be any electronic device capable of interacting with the Internet. Gateway 506 is designed to accommodate various types of devices by providing several different ports to connect to device 504 such as a USB port, a parallel port, an Ethernet port, etc. The multiple ports also allow gateway 506 to be connected to more than one device or more than one type of device.

In the preferred embodiment, gateway 506 is connected to a central office 510 over a telephone phone line because most houses and businesses are already equipped with one. Alternatively, gateway 506 is connected to central office 510 with an integrated services digital network (ISDN) line, a cable line, or other broadband links. Preferably, asynchronous digital subscriber line (ADSL) technology is used to transfer information from gateway 506 to central office 510. Other technologies can also be used, such as synchronous digital subscriber line (SDSL), cable technology, or other broadband links. Accordingly, the central office preferably includes equipment to handle whichever technology is used. Central office 510 is capable of supporting several gateway connections. Central office 510 routes information from the gateways to their perspective destinations and routes incoming information to addressed gateways. Preferably, central office 510 routes information either to some destination via Internet 530 or a protocol server 520. Although the protocol server 520 is shown as a separate entity, it is preferably physically located in the central office 110.

Configuration system 540 determines the configuration information needed for each gateway. Gateway 506 sends requests for configuration information to configuration system 540 via central office 510 and Internet 530. The configuration information returns information to gateway 506 in a similar fashion. In an alternative embodiment, the configuration system 540 is connected directly to central office 510, bypassing the need for an Internet connection to configure the gateway. Once gateway 506 is properly configured, device 504 may interact with the Internet 530 using broadband services.

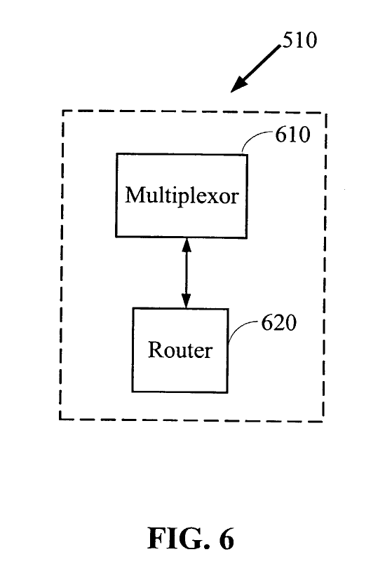

FIG. 6 displays components of central office 510. The primary function of the central office 510 is to route information either to a protocol server or to another destination via the Internet. In the preferred embodiment, the invention uses ADSL and asynchronous transfer mode (ATM) technology to route information. In that scenario, multiplexor 610 is a digital subscriber line access multiplexer (DSLAM) transferring the signal from gateway 506 onto an ATM network. Router 620 is an ATM router. One example of a commercially known ATM router is as a SHASTA router. The equipment used in central office 510 varies in alternative embodiments. For example, cable technology does not require a multiplexor, but still requires a router. SDSL technology uses a frame relay network with an HDLC. Regardless of the technology used, the function remains the same.

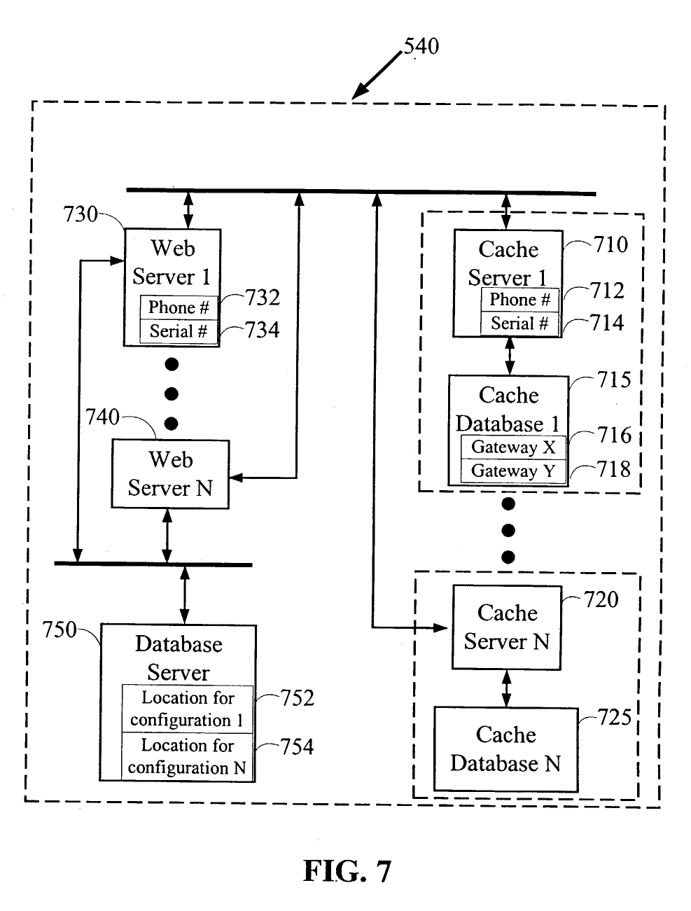

FIG. 7 shows the preferred embodiment of the configuration system 540. This specific embodiment will be referred to as an operational support system (OSS). The OSS supports a wide variety of functions including: customer sign-up, subscriber status, billing, technical support, termination of accounts, service operations, assignment information, network configuration, and network fault management. Configuration requests come to configuration system 540 via Internet 530. Requests are initially sent to one of many web servers which are connected to a database server 750.

In one example, web server 730 receives a signal that contains a gateway telephone number 732 and a gateway serial number 734. The web server 730 can use gateway telephone number 732, gateway serial number 734, or prompt the user for a valid login name and password to use. The web server only needs one valid identification information to retrieve from the database server 750 the location information 752 for gateway 506. The database server 750 contains the location of the configuration information for each gateway known. Once the web server 730 knows the location of the configuration information, it can redirect the configuration request to cache server 710, which accesses its cache database 715. Any web server can redirect a request to the appropriate cache server/cache database combination. For example, cache database 715 contains configuration information for Gateway X 716 and configuration information for Gateway Y 718. If Gateway Y is requesting configuration information, its request is sent to cache server 710. Cache server 710 uses either gateway phone number 712 or gateway serial number 714 to identify the gateway sending the signal. Cache server 710 retrieves the configuration information from the cache database 715 and returns it to the requesting gateway. If the gateway requesting the configuration information was not Gateway X or Gateway Y, it is sent to a different cache server that contains their respective configuration information. In the preferred embodiment, each cache server/cache database combination is located in separate locations from each other and the web servers and database server 750. Each cache server/cache database combination does not contain configuration information for every gateway. Although preferably there is some redundancy for backup purposes. Alternatively, the configuration system can be any type of system the can receive requests from a gateway and respond with the appropriate configuration information.

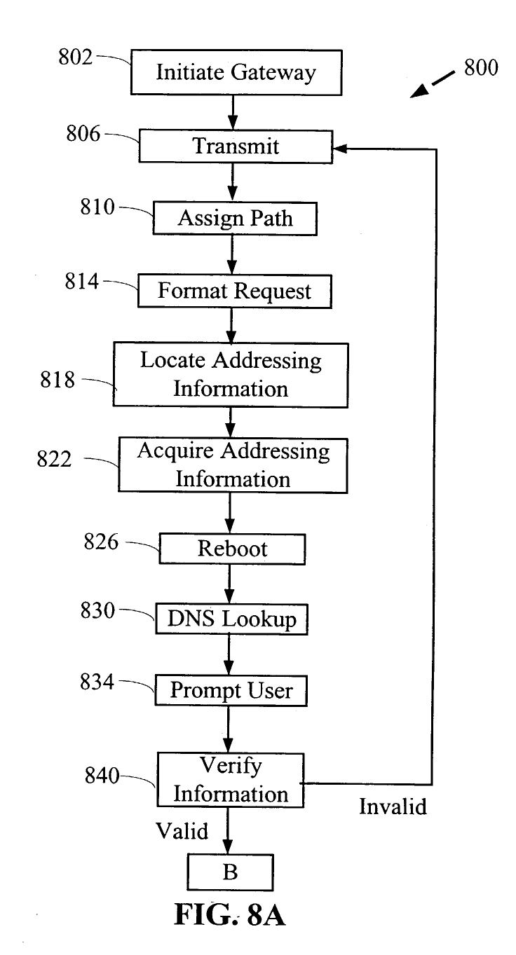

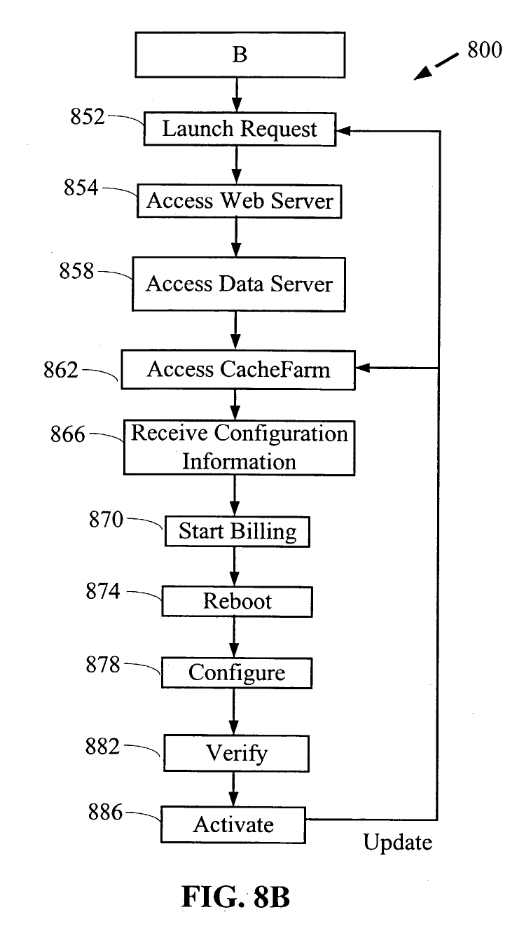

FIG. 8A is a flow chart describing the preferred method for configuring a gateway on a system that uses ADSL and ATM technology over a telephone line. When a gateway is acquired, it must be connected to a device capable of communicating with the Internet and plugged into an active phone line. When the gateway is turned on (step 802), it transmits a broadcast request (step 806) through the central office. The LEC assigns a permanent virtual circuit for the gateway on the DSLAM located in the central office (step 810). The PVC consists of a unique VPI/VCI pair. The broadcast request travels along the assigned PVC to an ATM router. The ATM router will append the VPI/VCI pair to a standardize request that it sends to a protocol server (step 814). In the preferred embodiment, the protocol server is a dynamic host configuration protocol (DHCP) server, and the standardize request is a specific DHCP configuration request called an Option 82.

Preferably, the DHCP's only function is to provide the gateway with sufficient information to reach the OSS. Minimizing the amount of information transmitted expedites the configuration process by making it less complicated. The DHCP server locates the addressing information based on the VPI/VCI pair or using the user's telephone number (step 818). In one embodiment, the addressing information includes: local area network (LAN) and wide area network (WAN) Internet protocol (IP) addresses, an OSS (the configuration system) hostname, and DNS information. The LAN IP addresses are IP addresses that are routable over the Internet. Although, the WAN IP addresses may be routable over the Internet, preferably, the DHCP assigns local WAN IP addresses that are not routable over the Internet. Alternatively, if the VPI/VCI pair is not unique and no user telephone number is given, the DHCP server will return a temporary IP address to use until it receives a telephone number. If the telephone number received is invalid, the DHCP server's response relays that information to the gateway.

Preferably, a local IP address is assigned to each port on the gateway. Since there are a limited number of routable IP addresses and that number is quickly diminishing, using local IP addresses avoids the problem of quickly depleting the pool of available IP numbers. Each port can still communicate through the gateway and each other using the local IP addresses. When accessing the Internet, the gateway uses the routable IP address. Additionally, with each port having its own IP address, the gateway serves as a miniature network for all the devices connected to the gateway. Since the local IP addresses are not routable, every gateway uses the same IP address for the same type of port. Thus, the manufacturer arbitrarily assigns the same local IP address for the same type of port on each gateway. This is very useful because the OSS and the DHCP server knows before being contacted by a gateway the local address for each port on the gateway and can initiate any contact.

The addressing information from the DHCP server is acquired by the gateway by being relayed back through the ATM router and the DSLAM (step 822). After retrieving a valid response from its broadcast request, the gateway reboots (step 826). The gateway performs a DNS lookup for the OSS location (step 830). In one embodiment, a DNS server contains similar information as the DHCP server. This redundancy provides a backup for one server if the other fails. Next, the gateway prompts the user to enter their telephone number (step 834). In an alternative embodiment, the gateway can prompt the user immediately after it sends its broadcast request. User actions are considerably slower than electronic communication so it is very likely the addressing information will be received before the user completes the prompt. Moreover, step 834 is not dependent on the addressing information, so there is no harm in receiving the user information before the addressing information.

Once the user replies, the gateway delivers a signal through the central office and the Internet to the OSS with the phone number and the gateway serial number (step 840). However, if the gateway was unable to retrieve addressing information it will return to step (step 806). The gateway repeats the process, excluding prompting the user, until it receives the correct addressing information. Not being able to retrieve the correct information may happen if the central office is using the same VPI/VCI pair for more then one gateway. When the gateway transmits a broadcast request after the user's reply to the prompt, the gateway includes the user's telephone number in its broadcast request. The DCHP server uses the telephone number to try and find the addressing information instead of using the VPI/VCI pair. Preferably, if the telephone number is invalid, the gateway will prompt the user for a new telephone number and repeat the process.

FIG. 8B is a continuation of the flow chart of FIG. 8A. Once the gateway receives proper addressing information from the DHCP server, it launches a request signal to the OSS via the Internet (step 852). Preferably, the request signal contains the user's telephone number and the gateway serial numbers. In one embodiment, the request signal is sent to the first available OSS web server. Alternatively, the request signal may be sent to the OSS web server physically closest. The OSS web server verifies the information sent in the request signal. If either number is valid, one of the OSS web servers runs a program to access a data server using the valid number (step 854). In an alternative embodiment, if both numbers are invalid, the OSS web server prompts the user for a login name and password. With a valid password and login, the OSS web servers runs the program to access the data server. The data server returns the identity of the cache farm web server that contains the configuration information for that particular user and gateway (step 858).

Preferably, once a gateway receives the location information of the cache farm server, it stores this location in memory. Thus, any time the gateway needs to communicate with the cache farm server it does not need to contact the OSS web servers because it already knows the location. This accelerates the process of future configurations, updates, or data exchanges. The cache farm web server and its corresponding cache farm database accesses the appropriate configuration information (step 862). The configuration information includes generic configurations in addition to configuration information specific to the requesting gateway. The gateway then receives the configuration information (step 866). In one embodiment, the cache farm web server and cache farm database contains configuration information, software updates, and user data uploaded from the gateway.

In the preferred embodiment, after receiving the configuration information, the gateway initiates the billing procedures, called first contact (step 870). First contact entails notifying the OSS that the configuration information has been received by the gateway. The OSS records that the gateway has received the configuration information and the time it was received. This information is important because it allows the manufacturer's billing procedures to start automatically at first contact. It also benefits the user because the first contact information contains the exact time of configuration and the exact services acquired. Thus, no one has to manually initiate any billing procedures because it is automatically incorporated into the system.

The gateway then reboots (step 874). Using the configuration information acquired from the OSS and the DHCP server, the gateway configures itself (step 878). Preferably, the gateway tests itself to ensure it is properly connected to the Internet by pinging a known Internet site, such as www.yahoo.com (step 882). Pinging refers to the use of a program to test whether a particular network destination is online by sending an Internet control message protocol (ICMP) echo request and waiting for a response. By using a known Internet site that is very likely to always be active, a successful ping will verify that the Internet connection is functional. If the ping was successful, the gateway activates itself for use by the consumer (step 886). In a personal computer embodiment, typical use entails accessing the Internet via the personal computer connected to the gateway. When activated, the gateway notifies the user so they can begin Internet use.

At predetermined times, the gateway reconfigures itself. Preferably, the gateway can also perform software updates, bug fixes, or add new features requested by the user. The gateway performs these functions by communicating with the OSS nightly, weekly, or at some regular interval. Therefore, when a bug needs to be fixed, software needs to be updated, or a new services need to be added, the manufacturer needs only update the OSS. When the gateway communicates with the OSS, it downloads the new information. Each gateway automatically checks the OSS and downloads information by repeating part of the process. This is illustrated in the flow chart with the arrow leading back to step 852 or step 862. The gateway starts at step 862 if it already knows the location of the cache farm server, otherwise step 852.

In the preferred embodiment, the gateway collects information about itself and the user. It sends this information to the OSS at predetermined time intervals. The cache farm database that stores the configuration information for a particular gateway collects this data, which is analyzed by the service provider. This allows the service provider to monitor the resources of their network, user preferences, service change requests, and the like.

Automating updates is a great advantage for both the manufacturer and the user. The manufacturer spends less time, money, and effort by only have to update the OSS. The user does not have to do anything, because the gateway will handle all of the updates automatically. Another advantage is evident when the gateway loses information. If the gateway loses all the information attained since it was initiated, it restarts the process starting with step 806. If it loses only the configuration information, it restarts the process at step 852 or step 862. Thus, neither the user nor the manufacturer is required to perform any actions in case of a malfunction because the gateway automatically reconfigures itself.

Once the gateway is activated, it will contain its own DHCP server. For the initial configuration steps, the gateway is a DHCP client of the original DHCP server (protocol server). After it has been activated with its own routable IP address, the gateway can act as a DHCP server with any attached devices acting as DHCP client.

Previously, most users would have to manually configure their personal computers to access broadband services. However, with the gateway serving as a DHCP server, it handles the IP addressing for its clients. Since the gateway configures itself, this eliminates all the configuration the user previously had to do. In an alternative embodiment, these gateway features also allow the user to use the gateway as its own web server.

This invention facilitates broadband Internet access for the consumer. Most methods currently known in the art are much more complicated and take more steps on the part of the user and/or service technicians to install and update their Internet access. With this invention, all the user has to do is connect the gateway to their device and a telephone line, install the gateway software on the device (e.g., a personal computer), which will prompt the user to enter their telephone number. The user does not need to make any other modifications, and they never have to physically modify their device, such as opening a computer to install hardware. After a few simple steps by the user, the gateway configures itself and the user is ready to access the Internet through broadband services.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. An apparatus for communicating with a communication network comprising:
a processor;
communication circuitry that interfaces with a communication network;
a bus connecting said processor to said communication circuitry;
a port connected to said bus that communicates using an external communication protocol specified by a peripheral device; and
a memory, comprising a translator module that converts signals between said external communication protocol and an internal communication protocol;
such that in use, communication signals transmitted to said port are converted from said internal communication protocol to said external communication protocol and signals received by said port are converted from said external communication protocol to said internal communication protocol.

2. The apparatus of claim 1, wherein said memory further comprises a routing module for routing signals between protocol addresses.

3. The apparatus of claim 1, wherein said apparatus includes a plurality of ports.

4. The apparatus of claim 3, wherein said routing module routes signals between said plurality of ports.

5. The apparatus of claim 1, wherein said port is selected from a group of interfaces consisting of Serial, Parallel, Ethernet, Small Computer System Interface (SCSI), Firewire/Institute of Electrical and Electronics Engineers (IEEE) 1394, and Universal Serial Bus (USB).

6. The apparatus of claim 1, wherein said memory further comprises support applications for peripheral devices such that said peripheral devices may be operated without resorting to support applications stored on other peripheral devices.

7. The apparatus of claim 1, wherein said memory further comprises an address module that configures protocol addresses for said port.

8. The apparatus of claim 1, wherein said memory further comprises a virtual path identifier/virtual channel identifier (VPI/VCI) autodetect module comprising a procedure to determine a line's local exchange carrier (LEC) VPI/VCI values.

9. The apparatus of claim 8, wherein said VPI/VCI autodetect module determines said line's LEC VPI/VCI values with a dynamic host configuration protocol (DHCP) broadcast request.

10. The apparatus of claim 1, wherein said memory further comprises a client module for communicating with a DHCP server.

11. The apparatus of claim 1, wherein said internal communication protocol and said external communication protocol is a single protocol.

12. The apparatus of claim 1, wherein said memory further comprises a diagnostics module that tests the quality of external data paths.

13. The diagnostics module of claim 12, wherein said module performs Time Delay Reflectometry (TDR) testing of standard telephone lines for bridge taps and load coils.

14. The diagnostics module of claim 12, wherein said module performs digital subscriber line (DSL) Tone Detection.

15. The apparatus of claim 1, wherein said interface circuitry accepts broad band communication signals.

16. The apparatus of claim 1, wherein said apparatus further comprises a modem as a backup redundant device that allows communication such that the apparatus is able to continue to operate even when communications through said interface circuitry are interrupted.

17. The apparatus of claim 1, wherein said memory is a Flash Programmable Read-Only Memory (PROM).

18. The apparatus of claim 1, wherein said port is a parallel port and said internal communication protocol is an Ethernet protocol.
